(19) United States
(12) Patent Application Publication
(10) Pub. No.: US 2026/0014944 A1
(43) Pub. Date: Jan. 15, 2026

(54) VEHICLE AUTOMATIC SNOWPLOW MODE

(71) Applicant: FORD GLOBAL TECHNOLOGIES, LLC, Dearborn, MI (US)

(72) Inventors: Stuart C. Salter, White Lake, MI (US); Andrew Brown, Royal Oak, MI (US); Brendan F. Diamond, Naples, FL (US); Peter Phung, Windsor (CA); Todd Ansbacher, Westland, MI (US); Jon Holt, Howell, MI (US)

(21) Appl. No.: 18/768,738

(22) Filed: Jul. 10, 2024

(51) Int. Cl. B60R 16/033

(52) U.S. Cl. CPC B60R 16/033; B60Y 2200/91; B60Y 2400/61

(57) ABSTRACT

One or more controllers, responsive to indication that a snowplow system is consuming power and a battery is discharging, reduce power supplied by the battery to loads by an amount that depends on an expected power consumption of the snowplow system such that the amount changes as the expected power consumption changes.

### TECHNICAL FIELD

This disclosure relates to vehicle power systems.

### BACKGROUND

Power systems within vehicles may be encompass a network designed to supply, manage, and distribute electrical energy to various components and subsystems. Included in this network is a battery (e.g., a lead-acid or lithium-ion battery), which powers functions such as starting the engine (if present), lighting, and infotainment systems. An alternator recharges the battery while the engine (if present) runs. Some vehicles also incorporate power management systems, including other power sources, to support applications like electric steering, braking systems, and additional accessories. These systems are integrated with controllers and sensors that monitor power usage, optimize energy distribution, and maintain battery health. Additionally, hybrid and electric vehicles may feature more complex power architectures, with high-voltage batteries and regenerative braking systems that recover energy.

### SUMMARY

A vehicle power system includes a battery and one or more controllers designed to manage power distribution. These controllers are programmed to respond to indications that a snowplow system attached to the vehicle is consuming power and the battery is being discharged. In such cases, the controllers reduce the power supplied by the battery to other vehicle loads. The reduction amount is adjusted based on the expected power consumption of the snowplow system, such that it changes dynamically as the expected power consumption varies.

A method for a vehicle involves reducing the power supplied by the vehicle's battery to various loads within the vehicle. This reduction is based on the power consumption associated with various systems, including an attached snowplow system. The amount of power reduction is adjusted according to changes in the power consumption so the battery experiences charge.

A vehicle comprises auxiliary loads, a snowplow system, a battery configured to power both the auxiliary loads and the snowplow system, and one or more controllers. These controllers are programmed to selectively disable certain auxiliary loads based on the expected power consumption of the snowplow system. This selective disabling helps to manage the power distribution from the battery.

### BRIEF DESCRIPTION OF THE DRAWINGS

FIGS. 1 and 2 are schematic representations of vehicles outfitted with snowplow systems.

FIGS. 3 and 4 are flows chart of algorithms for identifying snowplow operation and dynamic power control during the same.

### DETAILED DESCRIPTION

Embodiments described herein are merely examples, and other embodiments may take various and alternative forms. The figures provided are not necessarily to scale; some features may be exaggerated or minimized to highlight specific components. Therefore, the structural and functional details disclosed herein should not be interpreted as limiting but rather as a representative basis for instructing those skilled in the art.

Features illustrated and described with reference to any one of the figures may be combined with features illustrated in one or more other figures to produce embodiments that are not explicitly illustrated or described. The illustrated combinations of features provide representative embodiments for typical applications. Various combinations and modifications of these features, consistent with the teachings of this disclosure, may be desired for particular applications or implementations.

Snowplow systems are vehicle attachments, particularly in regions with heavy snowfall, enabling the clearing of snow from roads and other surfaces. The integration of these systems involves several electrical components. Most snowplows connect to the vehicle's 12V power supply, a standard in automotive electrical systems, which powers the control module or joystick and the hydraulic pump and valves that maneuver the plow blade.

The electrical connection with the vehicle's 12V battery may be made through a power harness that runs to the snowplow's control module. Typically located within the vehicle's cabin, this control module serves as the interface for the driver to operate the snowplow, featuring a joystick or buttons to control the plow's movements, such as lifting, lowering, and angling the blade. The control module communicates with the hydraulic system via electrical signals, dictating the actions to be taken.

The hydraulic system itself is powered by the 12V supply, where the hydraulic pump converts electrical energy into hydraulic power. This pump drives the hydraulic fluid through valves controlled by solenoids, which respond to signals from the control module, directing the fluid to appropriate cylinders and causing the plow to move as desired.

Driver assistance systems in some vehicles utilize cameras and proximity sensors to detect the attachment of a snowplow. These sensors identify the plow's presence at the front of the vehicle. Additionally, the motion of the snowplow can be monitored through electrical diagnostics. When in operation, the snowplow draws significant power from the vehicle's electrical system, leading to a noticeable voltage drop. This drop can be detected and used to indicate that the snowplow is active. The full field alternator, responsible for maintaining the vehicle's electrical charge, works harder to compensate for the power drawn by the snowplow's components, providing another indicator of the plow's motion.

Integrating a supercapacitor into the snowplow system can address high-power demand challenges, especially during startup when the 12V battery may not suffice. A supercapacitor, capable of rapid discharge and recharge, can be connected in series or parallel with the 12V battery or in other fashions, forming a hybrid energy storage system. During normal operation, the vehicle's alternator charges both the battery and the supercapacitor, which reaches full capacity quickly due to its high charge acceptance rate, ready to supply power when needed.

Upon activation of the snowplow system, the supercapacitor immediately provides the necessary power, alleviating the load on the 12V battery and preventing significant voltage drops. A power management system (PMS) within the vehicle may manage the distribution of power between the battery and the supercapacitor, directing surplus power from the alternator to recharge the supercapacitor during periods of low electrical demand.

Beyond startup assistance, the supercapacitor may support the snowplow during peak operational loads, such as when encountering heavy snow or requiring rapid directional changes. To monitor power delivery, a shunt resistor may be strategically placed just before the snowplow system, facilitating quick measurement of power flow. Positioned immediately upstream of the shunt, the supercapacitor ensures the shunt measures the combined current from both the supercapacitor and the battery.

The shunt resistor, producing a small voltage drop proportional to the current flow, allows continuous monitoring of the snowplow's power demand, providing data to the PMS. This setup enables the PMS to distinguish between normal power consumption and increased demand periods. In one configuration, the supercapacitor has two connections: one to the 12V battery and one to the snowplow system via the shunt. This allows the supercapacitor to charge from the battery while being ready to discharge into the snowplow system. Voltage and current measurements from the shunt can be communicated via the vehicle's Controller Area Network (CAN) bus, enabling real-time monitoring and management of power flow by the central control unit.

While this configuration is effective, other arrangements are also possible, such as using multiple supercapacitors in series or parallel to adjust voltage and capacity or employing advanced power electronics to dynamically manage energy flow between the battery, supercapacitor, and snowplow system.

By positioning the supercapacitor to source current directly to the plow while monitoring the current flow, the system can determine when the plow is active and switch to a “snowplow mode.” This initial movement is detected and characterized through current profile and voltage drop signatures, verified by the vehicle's sensors, such as cameras, ultrasonic, and radar systems. Upon activation, the system captures and recognizes the specific current signature associated with the plow's operation, storing data such as external temperature, 12V battery temperature, vehicle speed, and other parameters in, for example, a multivariate lookup table to predict power requirements under various conditions.

The system can also adapt to other accessories, like a salt spreader, connected via a bus bar connector. These accessories are recognized and characterized similarly to the snowplow, with movement inferred from current usage patterns, activating snowplow mode accordingly.

By knowing the power used by the snowplow, which varies with conditions, the system can dynamically manage the vehicle's electrical load, selectively shutting off non-essential accessories to prevent battery drain and permit charge of the battery via the alternator, thus reducing power supplied by the battery to accessories. This is in contrast to certain vehicles that provide a button or other interface that allow a driver to manually indicate the plow will be used, resulting in shut down of a fixed number of accessory loads. If power conservation measures are insufficient, the system may inform the operator of remaining operational time, preventing unexpected shutdowns. The snowplow mode may be deactivated when the power system returns to a positive charge margin, indicating the battery is replenished.

Additionally, during snowplow operations, the electric power assisted steering (EPAS) can be recalibrated. Lowering the current to the EPAS provides a heavier steering feel at low speeds, preferred by operators for better feedback when maneuvering around obstacles or curbs, while also saving power.

Recognizing snowplow activity leverages various sensors and systems. In certain alternative arrangements, analyzing driver demand torque requests compared to expected values for snow plowing can confirm the mode. High force at low speeds, considering vehicle speed, mass, and longitudinal change in speed, can also indicate snow plowing. Monitoring dynamic parameters like steering angle, pedal position, rates of speed change and turning, wheel speed, and shock absorber levels may also contribute to recognizing snowplow mode. Tire slip analysis, due to resistance from pushing snow, can also indicate plowing.

Artificial intelligence (AI) may enhance detection by analyzing data from front, rear, and 360-degree cameras, recognizing patterns indicating a snowplow attachment. Machine learning algorithms may increase accuracy over time, distinguishing different attachments and conditions.

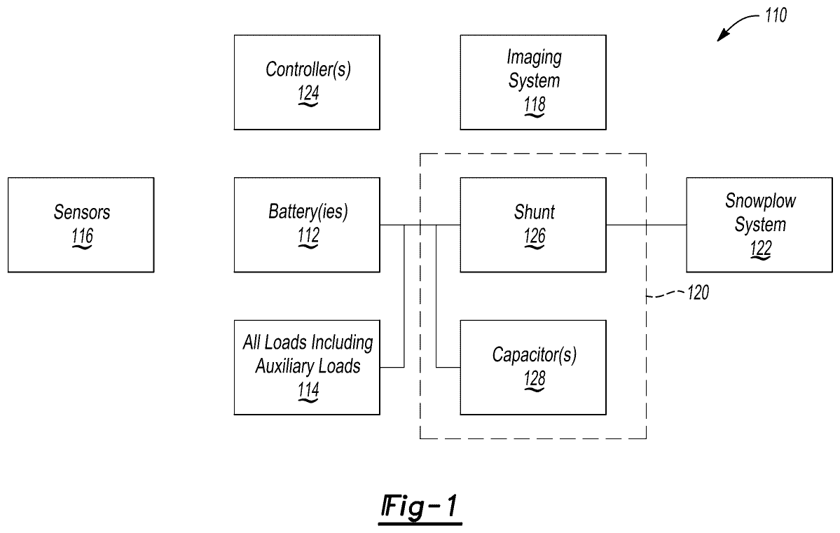

Referring to FIG. 1, a vehicle 110 includes, among other things, one or more batteries 112 (e.g., auxiliary batteries such at 12V batteries, traction batteries, etc.), a plurality of loads 114 including auxiliary loads (e.g., heated steering wheel, entertainment system, electronic power assist steering system, ambient lighting, etc.), a plurality of sensors 116 (e.g., speed sensor, steering wheel angle sensor, pedal position sensor, elevation sensor, wheels sensor, battery temperature sensor, battery voltage sensor, battery current sensor, ambient temperature sensor, etc.), an imaging system 118 (e.g., cameras, radar, ultrasonics, etc.), a supercapacitor 120, a snowplow system 122, and one or more controllers 124. The supercapacitor 120 includes a shunt 126 and one or more capacitors 128. The auxiliary batteries 112 are electrically connected with the loads 114, shunt 126, and capacitors 128. The shunt 126 is electrically connected between the auxiliary batteries 112 and snowplow system 122, and electrically connected between the capacitors 128 and snowplow system 122. The auxiliary batteries 112 may thus provide power to the loads 114, the supercapacitor 120, and snowplow system 122. The supercapacitor 120 may likewise provide power to the snowplow system 122. Intermediate electronic and power electronic devices between the illustrated components, such as power distribution hubs, bus bars, terminal outputs, etc., are not shown to facilitate ease of understanding and clarity. The controllers 124 are in communication with and/or exert control over the auxiliary batteries 112, loads 114, sensors 116, imaging system 118, supercapacitor 120, and snowplow system 122 via CAN, Local Interconnect Network (LIN), FlexRay, Ethernet or other such technologies.

As suggested above, the controllers 124 may monitor feedback from the imaging system 118 and snowplow system 122 and record the conditions present reported by the sensors 116, to learn how the power consumption of the snowplow system 122 behaves under various conditions. In one example, the imaging system 118 provides real-time visual and positional data, detecting the movement and operational status of the snowplow system 122. When the snowplow system 122 is activated and begins to move, the imaging system 118 captures this movement, which is then processed by the controllers 124. The controllers 124 correlate this visual data with electrical measurements from the shunt 126, which as mentioned above is placed to measure the current and voltage associated with the snowplow system 122. This correlation allows the controllers 124 to verify that the detected movement aligns with the expected electrical activity.

The shunt 126 provides measurements of the current drawn and the voltage drop as the snowplow system 122 operates. For example, when the snowplow begins to lift or angle, the current draw increases, resulting in a corresponding voltage drop. The controllers 124 record these electrical changes, associating them with specific operational states of the snowplow system 122 as detected by the imaging system 118. Additionally, the controllers 124 are arranged to track the current flow into (charge) or out of (discharge) the auxiliary batteries 112 via the sensors 116. These current sensors are arranged to measure current flow over a given time period, for example, 10 seconds or 60 seconds.

In conjunction with the data from the imaging system 118 and the shunt 126, the sensors 116 report various environmental and operational conditions, such as ambient temperature, battery temperature, and vehicle speed. These conditions influence the power consumption of the snowplow system 122. At lower ambient temperatures, the hydraulic fluid in the snowplow system 122 may thicken, requiring more power to move the plow. Similarly, higher vehicle speeds may necessitate more frequent adjustments to the plow's position, increasing power consumption.

By integrating data from these sources, the controllers 124 can learn how the power consumption of the snowplow system 122 behaves under different conditions. For example, under a specific set of conditions reported by the sensors 116—such as a low ambient temperature of −10° C., a moderate vehicle speed of 30 km/h, and a battery temperature of 5° C.—the controllers 124 can determine that the snowplow system 122 draws 50 amps of current and consumes 600 watts of power. This information is recorded and analyzed to predict future power requirements and optimize energy management. In this process, the controllers 124 also track how much current in terms of amps is flowing in to or out of the auxiliary batteries 112 over the monitored time period.

In another scenario, at a higher ambient temperature of 5° C., with the vehicle moving at a slower speed of 15 km/h, and the battery temperature at 10° C., the controllers 124 might observe that the snowplow system 122 draws 40 amps and consumes 480 watts of power. This lower power consumption could be attributed to less resistance in the hydraulic system and fewer positional adjustments needed at slower speeds.

The continuous monitoring and correlation of data allow the controllers 124 to build a comprehensive profile of the snowplow system's expected power consumption across various conditions. The controllers 124 thus know how much current on average the snowplow system 122 uses (in terms of amps) based on the temperature, speed, etc., reported by the sensors 116.

Other monitoring and correlation methodologies may include analyzing driver demand torque requests from the powertrain and/or leveraging artificial intelligence (AI) implemented by the controllers 124 to detect physical attachments to the vehicle. The controllers 124 can monitor the driver demand torque request from the powertrain to detect snowplow activity. This torque request can be compared against an expected value table that characterizes the conditions under which the vehicle 110 is plowing snow. When the vehicle 110 is moving substantial amounts of snow or dragging the plow on the ground, the powertrain's torque demand will be substantially higher. The controllers 124 can analyze this data alongside vehicle speed, a combined vehicle mass estimate (already calculated in the powertrain controller), and vehicle longitudinal change in speed. If the vehicle 110 is moving slowly despite a high torque demand, it suggests the vehicle 110 is in snowplow mode due to the increased resistance from pushing snow.

Additionally, the controllers 124 can check the steering wheel angle, pedal position, rates of change in speed, turning, wheel speed, and the level of shock absorbers or elevation changes via feedback from the sensors 116. These parameters help in detecting changes in the vehicle's dynamics, such as a forward shift in the center of gravity indicating that the snowplow is engaged. If the steering wheel angle indicates minor adjustments while the vehicle 110 moves slowly with high torque and a heavy front, it suggests active plowing. Similarly, analyzing tire slip can provide further confirmation. Excessive tire slip at low speeds and high torque indicates the tires are struggling against the added resistance of plowing snow.

AI can be employed to enhance detection through the vehicle's imaging system 118, which may include front and rear cameras and a 360-degree view camera. AI algorithms can process the visual data to identify obstructions or attachments indicative of snowplow usage. For example, if the front camera detects an obstruction that matches the shape and profile of a snowplow blade and the rear camera detects increased vehicle elevation, the system can confirm the attachment. Additionally, the AI can assess weight distribution changes captured by the 360-degree view camera, providing a comprehensive confirmation that a snowplow is attached and operational.

By integrating these detection methods, the controllers 124 can correlate this data with current and voltage measurements from the shunt 126, which monitors the power draw of the snowplow system 122. For example, if the AI detects a snowplow attached and the current and voltage data from the shunt 126 indicate high power consumption at startup, the controllers 124 can accurately identify the snowplow's operation. This information, combined with environmental and operational conditions reported by the sensors 116, such as ambient temperature, battery temperature, vehicle speed, etc., can help build a detailed profile of how the snowplow system 122 behaves under various conditions.

This monitoring and data correlation enable the controllers 124 to manage the vehicle's electrical load effectively. The controllers 124, using standard techniques, are aware of how much power (in terms of amps for example) each of the loads 114 is consuming at any given time via corresponding sensors and/or historical data. With this information and based on the expected power consumption of the snowplow system 122, the controllers 124 can selectively shut off only those auxiliary loads 114 necessary to prevent drain on the auxiliary batteries 112. This decision is informed by the conditions reported by the sensors 116 and the learned power profiles associated with those conditions. If the snowplow system 122 requires a significant amount of power due to low ambient temperatures and heavy snow conditions, the controllers 124 can prioritize maintaining power to certain of the auxiliary loads 114 while temporarily disabling other auxiliary loads 114, such as entertainment systems or cabin lighting. By doing so, the vehicle 110 ensures that certain functions remain operational without overtaxing the auxiliary batteries 112.

Furthermore, the controllers 124 can monitor the current flowing in and out of the auxiliary batteries 112 via the sensors 116 and determine the average current usage of the snowplow system 122 based on various environmental and operational conditions. With this information, along with the average current consumption of each of the auxiliary loads 114, the controllers 124 can disable just enough auxiliary loads 114 to prevent the auxiliary batteries 112 from discharging.

For example, if the sensors 116 indicate that the current flow out of the auxiliary batteries 112 during snowplow usage is 35 amps (a negative charge margin) and the average current consumption of the snowplow system 122 is 40 amps, with each auxiliary load 114 consuming an average of 10 amps, the controllers 124 can selectively disable 4 auxiliary loads 114. This would reduce current consumption by 40 amps, changing the condition from 35 amps flowing out of the auxiliary batteries 112 to 5 amps flowing into the auxiliary batteries 112 (a positive charge margin), accounting for the operation of an alternator that provides charge power to the auxiliary batteries 114.

If the expected average current consumption decreases to 20 amps during the same plowing event, the controllers 124 could re-enable 2 of the auxiliary loads 114. In another scenario, if during a different plowing event, such as snowplow operation at a different location or on a different day, the expected average current consumption is 50 amps, the controllers 124 could selectively disable 5 auxiliary loads 114, thereby reducing current consumption by 50 amps.

If the expected average current consumption is 50 amps and the auxiliary batteries 112 are discharging at 60 amps, the controllers 124 could selectively disable 7 auxiliary loads 114, resulting in the auxiliary batteries 112 charging at 10 amps. Similarly, if the snowplow system 122 is operating in extreme conditions where the average current consumption rises to 70 amps, the controllers 124 could disable 8 auxiliary loads 114 to achieve a balance.

Should these measures still prove insufficient to change the operating condition of the auxiliary batteries 114 from discharge to charge, the controllers 124 can then generate output for an alert to the operator of the remaining operational time for the vehicle 110 or for the snowplow system 122 (the time remaining before it is disabled) based on current power consumption rates and discharge of the auxiliary batteries 114. Additionally, the controllers 124 may re-enable the disabled auxiliary loads 114 if data about the auxiliary batteries 112 indicate the auxiliary batteries 112 are being charged rather than discharged during operation of the snowplow system 122.

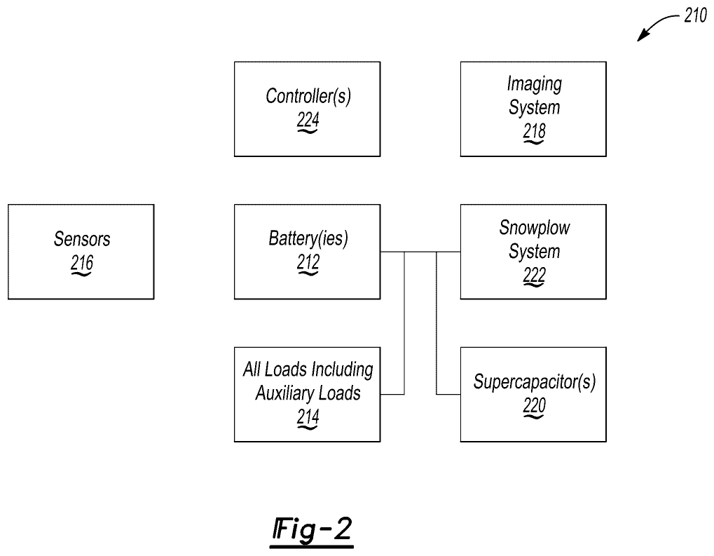

Referring to FIG. 2, a vehicle 210 includes, among other things, one or more batteries 212, a plurality of loads 214 including auxiliary loads, a plurality of sensors 216, an imaging system 218, a supercapacitor 220, a snowplow system 222, and one or more controllers 224. Similar numbered elements have similar descriptions and functions to that of FIG. 1, except that the supercapacitor 220 does not include a shunt. Thus, current and voltage to the snowplow system 222 cannot be directly measured as in the arrangement of FIG. 1. Estimates of such current and voltage would need to be made using standard techniques. The controllers 224 with data on total current provided by the batteries 212 and data on current consumed by devices other than the snowplow system 222 could infer the difference between the two as that amount of current being consumed by the snowplow system 224. The controllers 224 can selectively disable one or more of the loads 214 as described above based on current flow associated with the batteries 212, current consumed by the loads 214, and/or current consumed by the snowplow system 222.

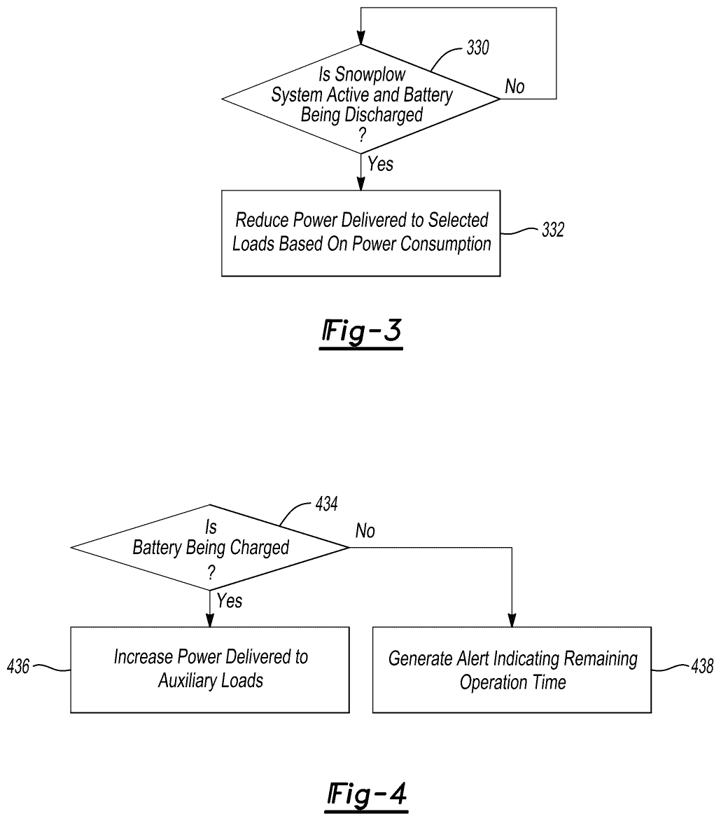

Referring to FIG. 3, it is determined whether a snowplow system is active and whether a battery is discharged at operation 330. If no, the algorithm returns to operation 330. If yes, power delivered to selected loads is reduced based on a power consumption associated at operation 332.

Referring to FIG. 4, it is determined whether a battery is being charged at operation 434. If yes, power delivered to loads is increased at operation 436. If no, an alert is generated indicating a remaining operation time at operation 438.

The algorithms, methods, and processes disclosed herein can be delivered to or implemented by a computer, controller, or processing device, including dedicated or programmable electronic control units. These algorithms, methods, or processes can be stored as data and instructions executable by a computer or controller in various forms. These forms include, but are not limited to, information permanently stored on non-writable storage media such as read-only memory devices and information alterably stored on writable storage media such as compact discs, random access memory devices, or other magnetic and optical media. Additionally, these algorithms, methods, or processes can be implemented in software executable objects. Alternatively, they can be embodied wholly or partially using suitable hardware components, such as application-specific integrated circuits, field-programmable gate arrays, state machines, or other hardware components, or a combination of firmware, hardware, and software components.

While exemplary embodiments are described above, it is not intended that these embodiments encompass all possible forms covered by the claims. The words used in the specification are descriptive rather than limiting, and it is understood that various changes may be made without departing from the spirit and scope of the disclosure.

As previously described, the features of various embodiments may be combined to form additional embodiments of the invention that may not be explicitly described or illustrated. While certain embodiments have been described as providing advantages or being preferred over other embodiments or prior art implementations with respect to specific desired characteristics, those skilled in the art recognize that one or more features or characteristics may be compromised to achieve desired overall system attributes, depending on the specific application and implementation. These attributes may include, but are not limited to, strength, durability, marketability, appearance, packaging, size, serviceability, weight, manufacturability, ease of assembly, and so on. Thus, embodiments described as less desirable than others with respect to one or more characteristics are not outside the scope of the disclosure and may be preferred for particular applications.

What is claimed is:

1. A power system for a vehicle, comprising:
a battery; and
one or more controllers programmed to, responsive to indication that a snowplow system attached to the vehicle is consuming power and the battery is discharging, reduce power supplied by the battery to loads of the vehicle by an amount that depends on an expected power consumption of the snowplow system such that the amount changes as the expected power consumption changes.

2. The power system of claim 1, wherein the one or more controllers are further programmed to reduce the power supplied such that the battery is charged.

3. The power system of claim 1, wherein the indication is based on image data and current data for the snowplow system.

4. The power system of claim 1, wherein the indication is based on speed data and current data for the snowplow system.

5. The power system of claim 1, wherein the indication is based on steering wheel angle data and pedal position data.

6. The power system of claim 1, wherein the one or more controllers are further programmed to, responsive to the battery being charged during the consuming, increase the power supplied to the loads.

7. The power system of claim 1, wherein the one or more controllers are further programmed to generate output for display indicating a remaining duration before which the vehicle shuts down.

8. The power system of claim 1, wherein one of the loads is an electronic power assist steering system.

9. The power system of claim 1 further comprising a supercapacitor configured to provide some of the power to the snowplow system.

10. The power system of claim 1 further comprising a shunt electrically connected between the battery and snowplow system.

11. A method for a vehicle comprising:
reducing power supplied by a battery of the vehicle to loads of the vehicle by an amount that depends on a power consumption associated with a snowplow system such that the battery experiences charge and the amount changes as the power consumption changes.

12. The method of claim 11 further comprising generating output for display indicating a remaining duration before which the snowplow system is disabled.

13. A vehicle comprising:
auxiliary loads;
a snowplow system;
a battery configured to power the auxiliary loads and snowplow system; and
one or more controllers programmed to selectively disable some of the auxiliary loads based on an expected power consumption value of the snowplow system.

14. The vehicle of claim 13, wherein the one or more controllers are further programmed to selectively disable some of the auxiliary loads such that the battery is charged.

15. The vehicle of claim 13, wherein the one or more controllers are further programmed to generate output for display indicating a remaining duration before which the snowplow system is disabled.

16. The vehicle of claim 13, wherein the one or more controllers are further programmed to learn the expected power consumption value.

17. The vehicle of claim 16, wherein the one or more controllers are further programmed to learn the expected power consumption value based on image data and current data for the snowplow system.

18. The vehicle of claim 13, wherein one of the auxiliary loads is an electronic power assist steering system.

19. The vehicle of claim 13 further comprising a supercapacitor configured to power the snowplow system.

20. The vehicle of claim 13 further comprising a shunt electrically connected between the battery and snowplow system.
